(19) United States
(12) Patent Application Publication
(10) Pub. No.: US 2009/0283569 A1
(43) Pub. Date: Nov. 19, 2009

(54) SYSTEM AND METHOD FOR MONITORING WELDING

(75) Inventors: Sivaramanivas Ramaswamy, Bangalore (IN); Thomas James Batzinger, Burnt Hills, NY (US); Waseem Ibrahim Faidi, Schenectady, NY (US); Gerhard Splitt, Koeln (DE); Thomas Rudolf Dahmen, Erftstadt (DE); York Oberdoerfer, Cologne (DE); Werner Roye, Erftstadt (DE); Johannes Georg Buechler, Siegburg (DE)

Correspondence Address: GENERAL ELECTRIC COMPANY;GLOBAL RESEARCH, PATENT DOCKET RM. BLDG. K1-4A59, NISKAYUNA, NY, 12309, US

(73) Assignees: GENERAL ELECTRIC COMPANY, Schenectady, NY (US); GE Inspection Technologies GmbH, Huerth (DE)

(21) Appl. No.: 12/119,519

(22) Filed: May 13, 2008

(51) Int. Cl. B23K 20/10; G01N 29/00

(52) U.S. Cl. 228/1.1; 73/622

(57) ABSTRACT

A system for monitoring a weld process is provided. The system includes an ultrasonic wave generator adapted to deliver an ultrasonic signal to a target material during a weld operation. The system also includes a pair of ultrasonic receiver elements with opposite directions of polarization relative to each other, the ultrasonic receiver elements configured to receive the ultrasonic signal propagated through the target material. The system further includes an electronic circuit coupled to the pair of ultrasonic receiver elements. The electronic circuit is configured to receive respective signals from the pair of ultrasonic receiver elements; wherein the respective signals comprise the ultrasonic signal and a noise signal. The electronic circuit is also configured to output the ultrasonic signal devoid of the noise signal. The system also includes a signal processor coupled to the electronic circuit, wherein the signal processor is configured to determine a quality level of a weld created during the weld operation by extracting data corresponding to the ultrasonic signal and comparing the data to a profile that corresponds to an acceptable quality level.

### BACKGROUND

The invention relates generally to a technique for monitoring a weld operation, and more particularly to monitoring a quality level of a weld during the weld operation.

Various types of welding operations are known and are in use. For example, two or more metal sheets may be welded by a spot welding operation. Spot welding utilizes a spot welding machine that includes two copper electrodes held in jaws of the spot welding machine. The material to be welded is clamped between the two electrodes. Typically, a pressure may be applied to hold the electrodes together and a flow of electric current is introduced through the electrodes and the material. Further, the resistance of the material being welded is substantially higher than that of the electrodes. As a result, enough heat is being generated to melt the metal. The pressure on the electrodes forces the molten spots in the two pieces of metal to unite and this pressure is held to facilitate the solidification of the metal. It is desirable to determine the quality of the weld generated through the weld operation to ensure the structural integrity of the welded systems such as automotive frames.

Unfortunately, the present weld monitoring techniques are ineffective to determine the weld quality during the weld operation due to various reasons. One of the common reasons includes interference from electromagnetic noise. Ultrasonic signals from a weld system are typically cluttered in an electromagnetic environment (EMI) leading to unmonitorable signals and an undesirable signal-to-noise ratio.

Additionally, in certain systems, excess spot welds are installed in components to ensure the structural integrity of the welded system. Such redundant welds lead to relatively higher process time and additional costs for the manufacturers. Further, excess welds in the system also increase the possibility for corrosion zones on the final product.

In certain systems, destructive testing may be employed to determine the quality of the weld. Typically, the materials joined by the weld process are separated by a hammer and a chisel to assess the strength of the weld and of the material surrounding the weld. Moreover, such destructive testing may be performed on a periodic basis to determine the quality of the weld process. Such testing is relatively time consuming and also leads to material waste.

In certain other systems, offline ultrasonic systems have been used to provide an indication of the weld quality. However, these systems provide an inspection of the weld quality after the process is completed and the weld nugget has solidified. Such systems do not provide information about the weld quality during the weld operation. Further, the existing ultrasonic systems may require a relatively large time for inspecting the weld quality of all welds of a component.

Accordingly, it would be desirable to develop an improved technique for monitoring the weld operation.

### BRIEF DESCRIPTION

In accordance with an embodiment of the invention, a system for monitoring a weld process is provided. The system includes an ultrasonic wave generator adapted to deliver an ultrasonic signal to a target material during a weld operation. The system also includes a pair of ultrasonic receiver elements with opposite directions of polarization relative to each other, the ultrasonic receiver elements configured to receive the ultrasonic signal propagated through the target material. The system further includes an electronic circuit coupled to the pair of ultrasonic receiver elements. The electronic circuit is configured to receive respective signals from the pair of ultrasonic receiver elements; wherein the respective signals comprise the ultrasonic signal and a noise signal. The electronic circuit is also configured to output the ultrasonic signal devoid of the noise signal. The system also includes a signal processor coupled to the electronic circuit, wherein the signal processor is configured to determine a quality level of a weld created during the weld operation by extracting data corresponding to the ultrasonic signal and comparing the data to a profile that corresponds to an acceptable quality level.

In accordance with another embodiment of the invention, a welding system is provided. The welding system includes a target material and a pair of welding shanks disposed on opposite sides of the target material, wherein the pair of welding shanks are configured to weld the target material. The system also includes an ultrasonic wave generator disposed on one of the pair of welding shanks, wherein the ultrasonic wave generator is configured to deliver an ultrasonic signal to the target material during a weld operation. The system further includes a pair of ultrasonic receiver elements disposed on another of the pair of welding shanks, wherein the pair of ultrasonic receiver elements have opposite directions of polarization relative to each other and are configured to receive the ultrasonic signal propagated through the target material. The system also includes an electronic circuit coupled to the pair of ultrasonic receiver elements. The electronic circuit is configured to receive respective signals from the pair of ultrasonic receiver elements; wherein the respective signals comprise the ultrasonic signal and a noise signal. The electronic circuit is also configured to output the ultrasonic signal devoid of the noise signal. The system further includes a signal processor configured to determine a quality level of a weld created during the weld operation by extracting data corresponding to the ultrasonic signal and comparing the data to a profile that corresponds to an acceptable quality level.

In accordance with another embodiment of the invention, a method of manufacturing a welding system is provided. The method includes providing an ultrasonic wave generator configured to deliver an ultrasonic signal to a target material during a weld operation. The method also includes providing a pair of ultrasonic receiver elements with opposite directions of polarization relative to each other, wherein the ultrasonic receiver elements are configured to receive the ultrasonic signal propagated through the target material. The method further includes providing an electronic circuit coupled to the pair of ultrasonic receiver elements. The electronic circuit is configured to receive respective signals from the pair of ultrasonic receiver elements; wherein the respective signals comprise the ultrasonic signal and a noise signal. The electronic circuit is also configured to output a desired signal devoid of the noise signal. The method also includes providing a signal processor configured to determine a quality level of a weld created during the weld operation by extracting data corresponding to the ultrasonic signal and comparing the data to a profile that corresponds to an acceptable quality level.

These and other advantages and features will be more readily understood from the following detailed description of preferred embodiments of the invention that is provided in connection with the accompanying drawings.

### DRAWINGS

FIG. 1 is a diagrammatic illustration of a system for monitoring a weld operation in accordance with an embodiment of the invention.

FIG. 2 is a diagrammatic illustration of an exemplary shank assembly employed in the system of FIG. 1.

FIG. 3 is a schematic illustration of an exemplary electronic circuit employed in the system of FIG. 1.

FIG. 4 is a flow chart representing steps in a method for monitoring a weld operation in accordance with an embodiment of the invention.

### DETAILED DESCRIPTION

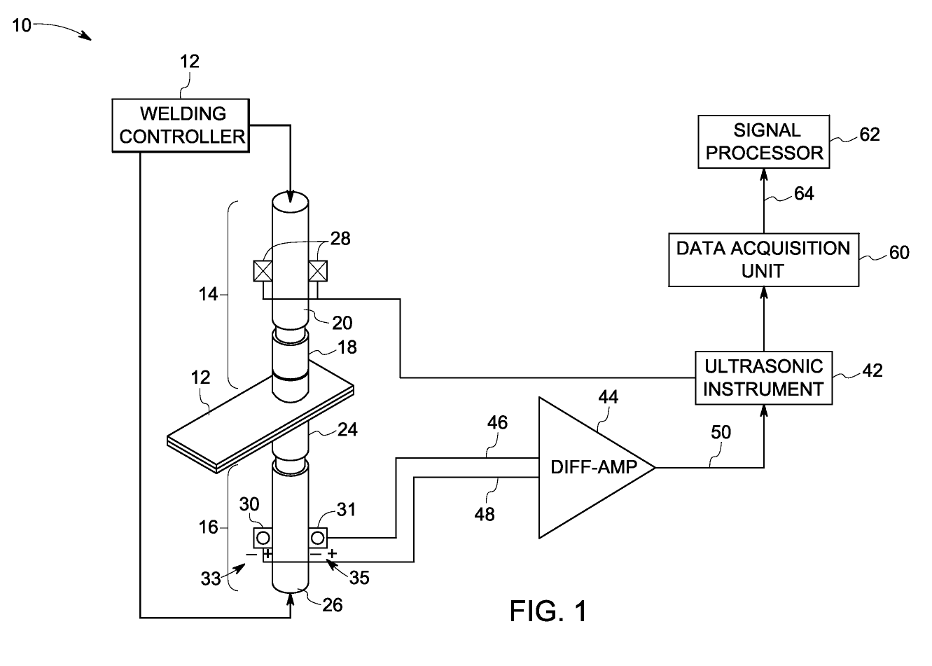

As discussed in detail below, embodiments of the invention include a system and method for online monitoring of a welding process such as, but not limited to, a spot welding process. FIG. 1 is a diagrammatic illustration of a system 10 for monitoring a weld operation for a target material 12. The system 10 includes a first electrode 14 and a second electrode 16. The first electrode 14 includes a probe tip 18 and is positioned so as to couple the probe tip 18 directly to the target material 12. The first electrode 14 also includes a shank 20 that is coupled to a welding controller 22. Similarly, the second electrode 16 includes a probe tip 24 and a shank 26 that is coupled to the welding controller 22. In one contemplated configuration, the system 10 includes an ultrasonic wave generator 28 that is adapted to deliver an ultrasonic signal to the target material 12. Additionally in this contemplated configuration, the system 10 includes a pair of ultrasonic receiver elements 30, 31 with opposite directions of polarization 33, 35 respectively, relative to each other and adapted to receive the ultrasonic signal propagated through the target material 12. It should be noted that the ultrasonic wave generator 28 may also include at least one pair of elements that act in tandem to generate torsional vibration in the system 10. Further details of operation in a torsional mode can be found in U.S. Patent Application Publication No. US 2007/0068907 A1 entitled “SYSTEM AND METHOD FOR MONITORING A WELD OPERATION”, filed on 28 Sep. 2005 and assigned to the same assignee as this application, the entirety of which is hereby incorporated by reference herein. In the illustrated embodiment, the ultrasonic wave generator 28 is disposed on the welding shank 20 on a first side of the target material 12. Further, the ultrasonic receiver elements 30, 31 are disposed on the welding shank 26 on a second side that is opposite the first side of the target material 12. In certain embodiments, the ultrasonic generator 28 and the ultrasonic receiver elements 30, 31 may be disposed on welding clamps of the system 10 for generating torsional guided waves.

In the embodiment illustrated in FIG. 1, the ultrasonic wave generator 28 and the ultrasonic receiver elements 30, 31 include at least two piezoelectric elements mounted on the welding shanks 20 and 26. Examples of piezoelectric elements include, but are not limited to, piezoelectric materials and piezoelectric composites. In one embodiment, the ultrasonic wave generator 28 and the ultrasonic receiver elements 30, 31 include electromagnetic acoustic transducers. In an alternate embodiment, the ultrasonic wave generator 28 and the ultrasonic receiver elements 30, 31 include capacitive micro-machined ultrasound transducers. In certain embodiments, parameters such as a source frequency, an aperture, a location, and an angle of incidence are selected to generate the desired ultrasonic signals. Moreover, a frequency of the generated ultrasonic signals is above 0.5 MHz. In one embodiment, the frequency of the ultrasonic signals is in the range of about 1 MHz to about 2 MHz. In yet another embodiment, a laser excitation source may be employed to generate ultrasonic waves.

In operation, the target material 12 is clamped between the first and second electrodes 14 and 16 under relatively high pressure. In certain embodiments, the target material 12 includes two or more sheets of metal such as steel and aluminum. Further, a flow of electrical current is introduced through the first and second electrodes 14 and 16 and through the target material 12. As a result, a sufficient amount of heat is generated to melt the metal. The pressure on the first and second electrodes 14 and 16 forces molten spots in the two pieces of the target material 12 to unite and this pressure is held to facilitate the solidification of the metal and the formation of the weld between the two pieces of the target material 12. In the illustrated embodiment, the pressure and current applied to the first and second electrodes 14 and 16 is controlled via the welding controller 22. For example, a piston (not shown) may be employed to apply a desired pressure to the target material 12. Such a piston may be coupled to the first and second electrodes 14 and 16. In an alternate embodiment, a servomotor may be employed to apply a desired pressure to the target material 12. Further, a power supply (not shown) is coupled to the first and second electrodes 14 and 16. Again, the amount of current applied to the first and second electrodes 14 and 16 via the power supply is controlled through the welding controller 22.

As illustrated in FIG. 1, the piezoelectric elements are configured to generate ultrasonic signals in the welding shanks 20 and 26. Data corresponding to a torsional mode from the ultrasonic signal is utilized to determine a quality level of the created weld. The ultrasonic wave generator 28 is coupled to an ultrasonic instrument 42 to facilitate generation of the ultrasonic signals. Further, the pair of ultrasonic receiver elements 30, 31 is coupled to an electronic circuit 44. The electronic circuit 44 receives respective signals 46, 48 from the pair of ultrasonic receiver elements 30, 31. The signals 46, 48 include respective ultrasonic components that are out-of-phase relative to each other due to the opposing directions of polarization 33, 35. Moreover, respective noise components of the signals 46, 48 arising out of ambient electromagnetic interference are in-phase with each other. These noise components need to be minimized or eliminated. Accordingly, the electronic circuit 44 includes a noise cancellation circuit such that it outputs ultrasonic signals 50 with minimized or eliminated noise components. In the illustrated embodiment, the electronic circuit 44 is a differential amplifier. The ultrasonic signals 50 are input into the ultrasonic instrument 42. A data acquisition unit 60 coupled to the ultrasonic instrument 42 extracts data from the ultrasonic signals 50.

A signal processor 62 is coupled to the data acquisition unit 60 to process the data 64 acquired from the data acquisition unit 60. In a particular embodiment, the signal processor 60 extracts the data corresponding to the torsional mode from the ultrasonic signals and compares the extracted data to a profile that corresponds to an acceptable quality level. Thus, the quality of the generated weld is monitored in real-time through the torsional modes generated in the system 10 by the piezoelectric elements disposed on the welding shanks 20 and 26. As will be appreciated by one skilled in the art, other types of modes of the ultrasonic signals may be monitored to determine the weld quality during the weld operation. Examples of such modes include a longitudinal mode, a flexural mode and so forth. In another embodiment, the signal processor 62 employs digital pattern classification for determining the quality level of the weld. In yet another embodiment, the signal processor 62 employs a time-frequency filter to separate the torsional mode from the ultrasonic signal.

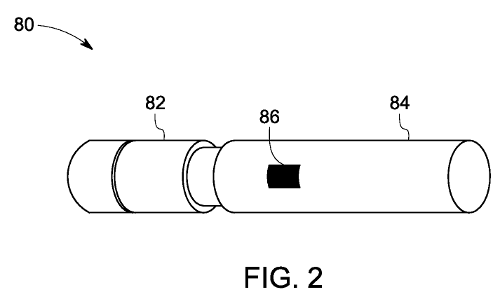

FIG. 2 illustrates an exemplary shank and cap assembly 80 employed in a system similar to the system 10 of FIG. 1. As illustrated, the assembly 80 includes a welding tip 82 and a welding shank 84. The piezoelectric elements forming the ultrasound wave generator 28 and the ultrasound receiver elements 30, 31 (FIG. 1) may be mounted directly on the surface of the welding shank 84. Alternatively, the piezoelectric elements may be mounted on the surface of the welding shank 84 via angle wedges. Further, features such as a flat cutout 86 may be machined on the surface of the welding shank 84 to facilitate the mounting of the piezoelectric elements. In one embodiment, two or more piezoelectric elements, which are shear probes, are mounted on the surface of the welding shank 84 and oriented such that torsional guided waves are generated in the assembly 80.

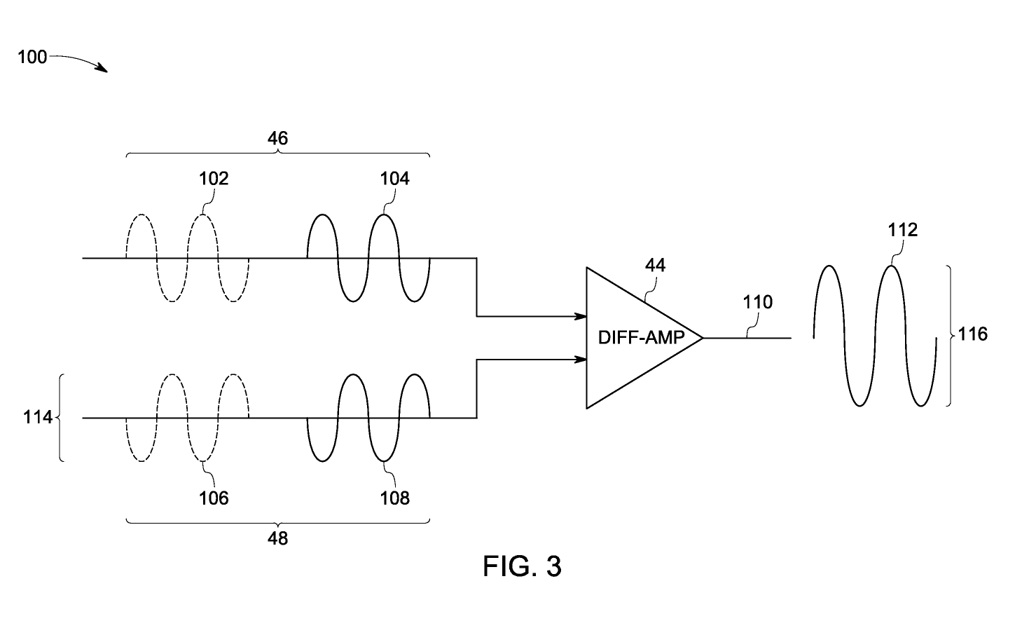

FIG. 3 is a schematic illustration of a signal processing algorithm 100 employed in an exemplary electronic circuit, such as the differential amplifier 44 in FIG. 1. Signals 46, 48, as referenced in FIG. 1, are input into the differential amplifier 44, which performs a noise cancellation based upon common mode rejection. The signal 46 includes an ultrasonic component 102 and a noise component 104. Similarly, the signal 48 includes an ultrasonic component 106 out-of-phase relative to the ultrasonic component 102 and a noise component 108 in-phase with the noise component 104. The differential amplifier 44 receives signals 46, 48 as inputs and performs a common mode rejection. Consequently, the noise components 104, 108 are subtracted and the ultrasonic components 102, 106 are added. A resulting output signal 110 includes only an ultrasonic component 112 with an amplitude, referenced by 116, which is double an amplitude 114 of either of the ultrasonic components 102, 106.

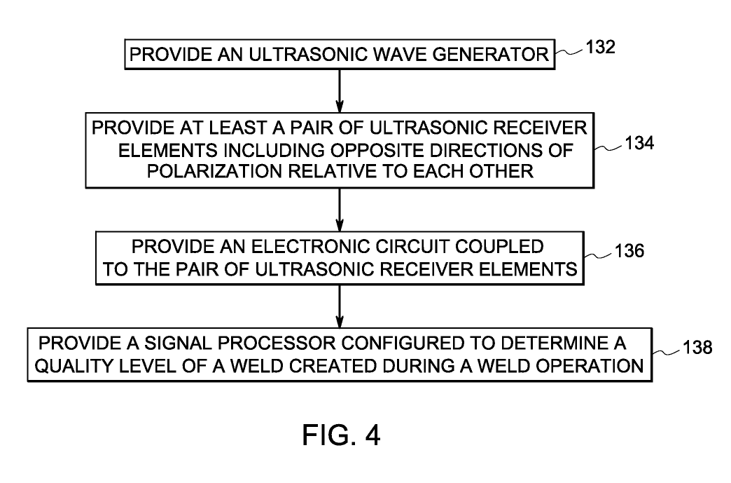

FIG. 4 is a flow chart representing steps in a method for manufacturing a weld system. The method includes providing an ultrasonic wave generator configured to deliver an ultrasonic signal to a target material during a weld operation in step 132. In a particular embodiment, the ultrasonic wave generator is disposed on a welding shank on a first side of the target material. A pair of ultrasonic receiver elements with opposite directions of polarization relative to each other are provided in step 134, wherein the ultrasonic receiver elements receive the ultrasonic signal propagated through the target material. In one embodiment, the pair of ultrasonic receiver elements is disposed on the welding shank on a second side that is opposite to the first side of the target material. In another embodiment, one of the pair of ultrasonic receiver elements is turned upside down to provide opposite directions of polarization. In yet another embodiment, a live and a ground wire on an electrical connector of one of the ultrasonic receiver elements is exchanged to provide opposite directions of polarization.

An electronic circuit coupled to the pair of ultrasonic receiver elements is provided in step 136. The electronic circuit receives respective signals from the pair of ultrasonic receiver elements; wherein the respective signals include the ultrasonic signal and a noise signal. The electronic circuit further outputs a desired signal devoid of the noise signal. In an exemplary embodiment, a differential amplifier is provided. Furthermore, a signal processor is provided in step 138 to determine a quality level of a weld created during the weld operation by extracting data corresponding to the ultrasonic signal and compare the data to a profile that corresponds to an acceptable quality level. In one embodiment, the signal processor employs digital pattern classification for determining the quality level of the weld. In another embodiment, the signal processor employs a time-frequency filter to separate a torsional mode from the ultrasonic signal.

The various embodiments of a system and method for monitoring welding described above thus provide a convenient and efficient means of utilizing an ultrasonic spot weld monitoring system in an electromagnetic noisy environment. Moreover, the method described herein facilitates real-time monitoring of the quality of the weld created during the weld operation process. Reducing the noise component in the signal and hence increasing the signal to noise ratio, enables utilizing advanced signal processing and pattern recognition techniques to provide quantitative measurements of the weld quality, such as the online measurement of the weld nugget diameter and thickness. Advantageously, the real-time monitoring of the weld enables real-time control of the weld quality. The technique also allows for usage of externally mounted ultrasonic transducers for weld monitoring, thus minimizing a cycle cost for probe replacement.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, the use of a capacitive micro-machined ultrasound transducer with respect to one embodiment can be adapted for use with a signal processor employing a digital pattern classification for determining quality level of a weld described with respect to another. Similarly, the various features described, as well as other known equivalents for each feature, can be mixed and matched by one of ordinary skill in this art to construct additional systems and techniques in accordance with principles of this disclosure.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A system for monitoring a weld process, comprising:
an ultrasonic wave generator adapted to deliver an ultrasonic signal to a target material during a weld operation;
a pair of ultrasonic receiver elements with opposite directions of polarization relative to each other, the ultrasonic receiver elements configured to receive the ultrasonic signal propagated through the target material in an electromagnetic interference environment;
an electronic circuit coupled to the pair of ultrasonic receiver elements, the electronic circuit configured to:
receive respective signals from the pair of ultrasonic receiver elements in an electromagnetic interference environment; the respective signals comprising the ultrasonic signal and a noise signal; and
output the ultrasonic signal devoid of the noise signal in an electromagnetic interference environment; and
a signal processor coupled to the electronic circuit, the signal processor configured to determine a quality level of a weld created during the weld operation by extracting data corresponding to the ultrasonic signal and comparing the data to a profile that corresponds to an acceptable quality level.

2. The system of claim 1, wherein the ultrasonic wave generator is disposed on a welding shank on a first side of the target material.

3. The system of claim 1, wherein the pair of ultrasonic receiver elements are disposed on a welding shank on a second side that is opposite a first side of the target material.

4. The system of claim 2, wherein the ultrasonic wave generator and the ultrasonic receiver elements comprise piezoelectric elements mounted on the welding shank, wherein the piezoelectric elements are adapted to generate torsional guided ultrasonic signals in the welding shank.

5. The system of claim 4, wherein the piezoelectric elements comprise piezoelectric materials or piezoelectric composites.

6. The system of claim 1, wherein the electronic circuit comprises a differential amplifier.

7. The system of claim 1, wherein the noise signal comprises a radiation signal due to electromagnetic interference.

8. The system of claim 1, wherein the ultrasonic wave generator and the pair of ultrasonic receiver elements comprise electromagnetic acoustic transducers or capacitive micro-machined ultrasound transducers.

9. The system of claim 1, wherein the signal processor employs digital pattern classification for determining the quality level of the weld created during the weld operation.

10. The system of claim 1, wherein the signal processor employs a time-frequency filter to separate a torsional mode from the ultrasonic signal.

11. A welding system, comprising:
a target material;
a pair of welding shanks disposed on opposite sides of the target material, the pair of welding shanks configured to weld the target material;
an ultrasonic wave generator disposed on one of the pair of welding shanks, the ultrasonic wave generator configured to deliver an ultrasonic signal to the target material during a weld operation;
a pair of ultrasonic receiver elements disposed on another of the pair of welding shanks, the pair of ultrasonic receiver elements having opposite directions of polarization relative to each other and being configured to receive the ultrasonic signal propagated through the target material in an electromagnetic interference environment;
an electronic circuit coupled to the pair of ultrasonic receiver elements, the electronic circuit configured to:
receive respective signals from the pair of ultrasonic receiver elements in an electromagnetic interference environment; the respective signals comprising the ultrasonic signal and a noise signal; and
output the ultrasonic signal devoid of the noise signal in an electromagnetic interference environment; and
a signal processor configured to determine a quality level of a weld created during the weld operation by extracting data corresponding to the ultrasonic signal and comparing the data to a profile that corresponds to an acceptable quality level.

12. The system of claim 11, wherein the electronic circuit comprises a differential amplifier.

13. A method of providing a welding system, comprising:
providing an ultrasonic wave generator configured to deliver an ultrasonic signal to a target material during a weld operation;
providing a pair of ultrasonic receiver elements with opposite directions of polarization relative to each other, the ultrasonic receiver elements configured to receive the ultrasonic signal propagated through the target material in an electromagnetic interference environment;
providing an electronic circuit coupled to the pair of ultrasonic receiver elements, the electronic circuit configured to:
receive respective signals from the pair of ultrasonic receiver elements in an electromagnetic interference environment; the respective signals comprising the ultrasonic signal and a noise signal; and
output a desired signal devoid of the noise signal in an electromagnetic interference environment;
providing a signal processor configured to determine a quality level of a weld created during the weld operation by extracting data corresponding to the ultrasonic signal and comparing the data to a profile that corresponds to an acceptable quality level.

14. The method of claim 13, wherein said providing an ultrasonic wave generator comprises disposing the ultrasonic wave generator on a welding shank on a first side of the target material.

15. The method of claim 13, wherein said providing at least the pair of ultrasonic receiver elements comprises disposing the ultrasonic receiver elements on a welding shank on a second side that is opposite a first side of the target material.

16. The method of claim 13, wherein said providing an electronic circuit comprises providing a differential amplifier.

17. (canceled)

18. (canceled)

19. (canceled)

20. (canceled)
